(19) United States
(12) Patent Application Publication
(10) Pub. No.: US 2021/0178342 A1
(43) Pub. Date: Jun. 17, 2021

(54) REMOVING METAL IONS WITH A MEMBRANE BASED ON ANIONIC POLYARYLENE ETHERSULFONE AND A CATIONIC POLYMER WITH AMINO GROUPS

(71) Applicant: DuPont Safety & Construction, Inc., Wilmington, DE (US)

(72) Inventors: Oliver Gronwald, Ludwigshafen (DE); Martin Weber, Ludwigshafen (DE); Martin Heijnen, Greifenberg (DE)

(21) Appl. No.: 16/770,823

(22) PCT Filed: Dec. 3, 2018
(86) PCT No.: PCT/EP2018/083365

§ 371 Date: Jun. 8, 2020

(30) Foreign Application Priority Data
Dec. 12, 2017 (EP) 17206682.1
Apr. 17, 2018 (EP) 18167780.8

(51) Int. Cl. B01D 71/82; B01J 41/13; B01J 41/05; B01J 39/05; B01J 39/19; B01J 39/20; B01J 47/12; B01J 49/20; B01J 49/53; B01J 49/57; B01D 61/14; B01D 71/68; B01D 71/60; B01D 69/02; B01D 65/02; C02F 1/44; C02F 1/42

(52) U.S. Cl. CPC B01D 71/82; C02F 2101/10; B01J 41/05; B01J 39/05; B01J 39/19; B01J 39/20; B01J 47/12; B01J 49/20; B01J 49/53; B01J 49/57; B01D 61/145; B01D 71/68; B01D 71/60; B01D 69/02; B01D 65/02; C02F 1/444; C02F 1/42; B01D 2321/162; B01D 2325/14; B01D 2325/16; B01D 2325/18; B01D 2325/20; B01D 2325/42; B01J 41/13

(57) ABSTRACT

The present invention relates to a method for removing metal ions from an aqueous system comprising a step of filtering the aqueous system through a loaded membrane which contains a carrier membrane based on a polyarylene ethersulfone which carries anionic groups, and a cationic polymer which is a polymer comprising primary and/or secondary amino groups. The invention further relates to a loaded membrane which contains a carrier membrane based on a polyarylene ethersulfone which carries anionic groups, and a cationic polymer which is a polymer comprising primary and/or secondary amino groups.

The present invention relates to a method for removing metal ions from an aqueous system comprising a step of filtering the aqueous system through a loaded membrane which contains a carrier membrane based on a polyarylene ethersulfone which carries anionic groups, and a cationic polymer which is a polymer comprising primary and/or secondary amino groups. The invention further relates to a loaded membrane which contains a carrier membrane based on a polyarylene ethersulfone which carries anionic groups, and a cationic polymer which is a polymer comprising primary and/or secondary amino groups.

Different types of membranes play an increasingly important role in many fields of technology. In particular, methods for treating water rely more and more on membrane technology. There is a need for membranes with improved separation characteristics. In particular, it is desirable to have membranes capable of removing metal ions from water.

The object was solved by a method for removing metal ions from an aqueous system comprising a step of filtering the aqueous system through a loaded membrane which contains
a carrier membrane based on a polyarylene ethersulfone which carries anionic groups, and
a cationic polymer which is a polymer comprising primary and/or secondary amino groups.

The object was also solved by a loaded membrane which contains
a carrier membrane based on a polyarylene ethersulfone which carries anionic groups, and
a cationic polymer which is a polymer comprising primary and/or secondary amino groups.

Typically, a membrane is a discrete, thin interface that moderates the permeation of chemical species in contact with it. Some species may be readily transported through the membrane, while other species may be retained or slowed down. This typically leads to permselectivity, that is, selective permeation of species.

The filtering of the aqueous system may be made by conventional filtration processes and parameters, which are known to experts.

The aqueous system may contain at least 80 wt %, preferably at least 90 wt %, and in particular at least 95 wt % water. The aqueous system is for example industrial waste water, municipal waste water, sea water, brackish water, surface water, drinking water, mining water, waste water from oil wells or power plants.

Removing metal ions from the aqueous system may result in a decrease of the concentration of the metal ions in the aqueous system when comparing the concentration before and after the filtering step. The concentration of the metal ions in the aqueous system is usually reduced by at least 50 mol %, preferably by at least 90 mol %, and in particular at least 95 mol %, based on the concentration of the metal ions before the filtering step.

The metal ions are usually selected from Ca, Mg, Al, Cu, Ni, Pb, Zn, Sb, Co, Cr, Cd, Hg, Po, Ra, Rn, Th, U, Pu, Sr, Cs, Pm and/or Ag. The metal ions are preferably present as cations. One type or multiple kinds of metal ion may be removed in the filtering step. The metal ions may also be present as isotopes.

The concentration of the metal ions in the aqueous system may be 1 ppb to 100 ppm, preferably 1 ppb to 10 ppm, and in particular 1 ppb to 5 ppm.

The loaded membrane contains the carrier membrane and the cationic polymer. In the loaded membrane the cationic polymer is preferably bound to the carrier polymer via ionic interaction and not via chemical bonds. The loaded membrane is free of crosslinkers, e.g. of crosslinkers which can bind the carrier polymer to the cationic polymer via chemical bonds.

The loaded membrane has usually a molecular weight cut-off (MWCO) from 500 to 20,000 Dalton (Da), preferably from 600 to 15,000 Da, and in particular from 700 to 10,000 Da. In another form the loaded membrane has a molecular weight cut-off from 1500 to 30,000 Da, preferably from 2000 to 15,000 Da, and in particular from 2500 to 10,000 Da. In another form the loaded membrane has a molecular weight cut-off of at least 1000 Dalton, preferably at least 1800 Da, and in particular at least 2500 Da.

The loaded membrane has usually a pure water permeability (PWP) from 20 to 500 LMH/bar, preferably from 40 to 300 LMH/bar, and in particular from 50 to 150 LMH/bar. In another form the loaded membrane has a pure water permeability of at least 20 LMH/bar, preferably at least 40 LMH/bar, and in particular at least 50 LMH/bar.

The loaded membrane is usually a ultrafiltration membrane. Preferably, the loaded membrane is an ultrafiltration membrane, where the PWP is from 20 to 500 LMH/bar, and optionally that the MWCO is from 500 to 20,000 Dalton, preferably from 600 to 15,000 Da, and in particular from 700 to 10,000 Da.

In another preferred form the loaded membrane is an ultrafiltration membrane, where the PWP is at least 20 LMH/bar, preferably at least 40 LMH/bar, and in particular at least 50 LMH/bar, and optionally that the molecular weight cut-off is at least 900 Dalton, preferably at least 1300 Da, and in particular at least 1800 Da.

The cationic polymer is a polymer comprising primary and/or secondary amino groups, wherein primary amino groups are preferred. Optionally, the cationic polymer may comprise ternary or quaternary amino groups.

Usually, the primary and/or secondary amino groups are at least partly present in their cationic form. The degree of cationic form may be adjusted by the pH of the environment of the cationic polymer.

The cationic polymer is usually soluble in water, e.g. at least 0.1 wt %, preferably at least 3 wt % in water at 20° C. and pH 1.

Suitable cationic polymers are polyethyleneimine, polyethyleneimine-polyvinylalcohol, poly-L-lysine, diethylaminoethyl-dextran, chitosan, polyetheramine, and polymers based on vinylamine, wherein polyethyleneimine and polyethyleneimine-polyvinylalcohol are preferred.

A preferred cationic polymer is polyethyleneimine, which may be linear or branched.

The average molecular weight of the polyethyleneimine is usually from 300 to 100.000 g/mol, preferably from 500 to 50.000 g/mol, and in particular form 600 to 30.000 g/mol.

The carrier membrane is based on a polyarylene ethersulfone which carries anionic groups.

Suitable anionic groups are sulfonate, carboxylate, or phosphonate groups, wherein sulfonate and carboxylate groups are preferred. Mixtures of anionic groups are also possible. In a particular form the anionic groups are sulfonate groups. In another particular form the anionic groups are carboxylate groups.

Usually, 0.1 to 40 mol %, preferably 0.3 to 30 mol %, and in particular 0.5 to 25 mol % of the repeating units of the polyarylether sulfone carry at least one anionic group, e.g. a sulfonate or a carboxylate group.

The carrier membrane has usually a molecular weight cut-off (MWCO) from 10,000 to 200,000 Dalton, preferably from 15,000 to 100,000 Da, and in particular from 15,000 to 50,000 Da.

The carrier membrane is usually a UF membrane, which may have an average pore diameter of 2 nm to 50 nm, preferably 5 to 40 nm, more preferably 5 to 20 nm.

The carrier membrane has usually a pure water permeability (PWP) from 200 to 1000 LMH/bar, preferably from 300 to 800 LMH/bar, and in particular from 300 to 600 LMH/bar.

The carrier mebrane is preferably based on
a) a sulfonated polyarylene ethersulfone;
b) a carboxylated polyarylene ethersulfone; or
c) a carrier polymer obtainable by reacting
   at least one aromatic dihalide (M1a),
   a dialkali metal salt of at least one aromatic diol (M2a), and
   at least one anionic monomer, where the anionic monomer is
      a sulfonated monomer selected from sulfonated aromatic dihalide (M1b) and/or sulfonated aromatic diol (M2b), and/or
      a carboxylic monomer selected from aromatic diols which carry a carboxylate group (M2c).

In a preferred form the carrier membrane is based on the sulfonated polyarylene ethersulfone.

The term “sulfonated” means that a certain proportion of the repeating units of the polyarylene ethersulfone is sulfonated and carry at least one (e.g. one or two, preferably two) sulfonate group bound to an aryl group. The sulfonate group may be present in anionic form —SO₃⁻ or as acid form —SO₃H, wherein the anionic form may be present for as alkali metal salt (e.g. Na, K or Li).

Typically, 0.1 to 20 mol %, preferably 0.5 to 10 mol %, and in particular 1 to 5 mol % of the repeating units of the polyarylene ethersulfone carry at least one (e.g. one or two, preferably two) sulfonate group bound to an aryl group. The amount of the repeating units of the polyarylene ethersulfone which carry at least one sulfonate group bound to an aryl group can be determined using ¹H-NMR spectroscopy or potentiometric titration or IR-spectroscopy.

Suitable sulfonated polyarylene ethersulfone are based on polyarylene ethersulfone which comprise at least one (e.g. one, two or three) repeating unit selected from the formlae Ia to Io, preferably from Ia, Ig or Ik, and in particular from Ig:

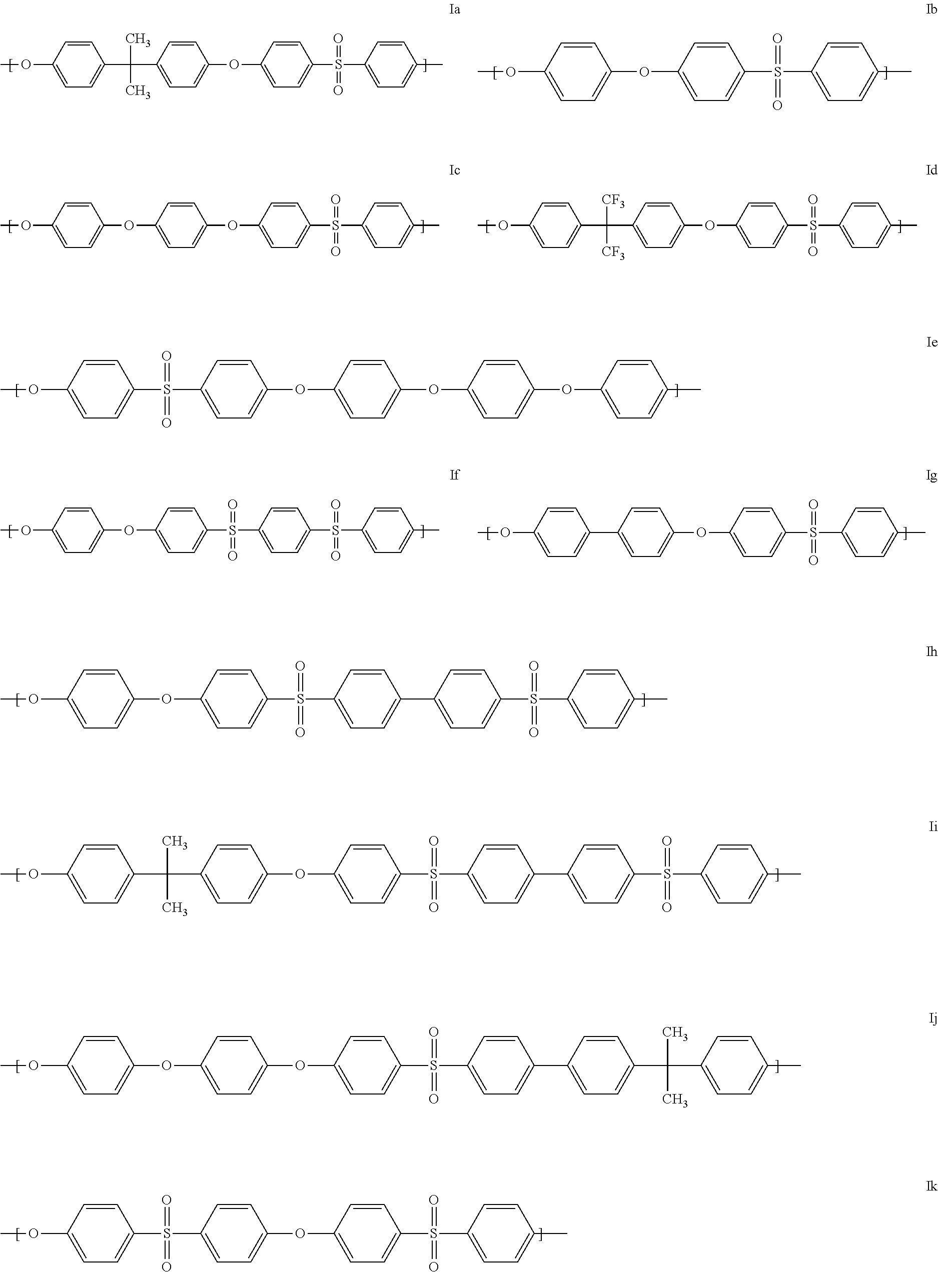

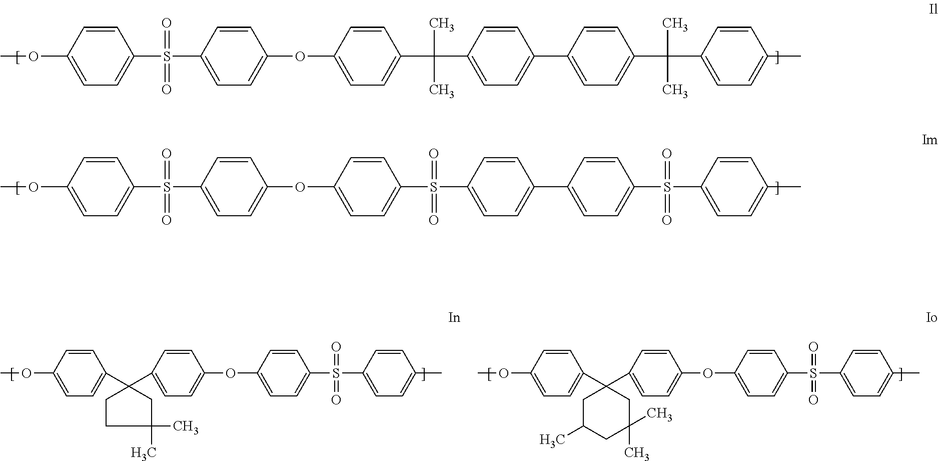

In the repeating units Ia to Io one or more 1,4-dihydroxyphenyl units may be replaced by resorcinol or dihydroxynaphthalene units.

In a preferred form the sulfonated polyarylene ethersulfone are based on polyarylene ethersulfone which comprise two repeating units selected from the formulae Ia to Io, preferably selected from Ik and Ig or from Ik and Ib.

In another preferred form the sulfonated polyarylene ethersulfone is based on a polyarylene ethersulfone which comprises essentially only one kind of the repeating unit selected from the formlae Ia to Io, preferably from Ia (also known as polysulfone PSU), Ig (also known as polyphenylsulfone PPSU), and in particular from Ig.

The sulfonated polyarylene ethersulfone is preferably a sulfonated polysulfone (sPSU), a sulfonated polyethersulfone (sPESU), a sulfonated polyphenylenesulfone (sPPSU), or a mixture thereof.

The sulfonated polyarylene ethersulfone is in particular a sulfonated polyphenylenesulfone. The sulfonated polyarylene ethersulfone may be prepared by sulfonation of a polyarylether sulfone, for example by sulfonation with concentrated H₂SO₄.

In another preferred form the carrier membrane is based on the carboxylated polyarylene ethersulfone.

The term “carboxylated” means that a certain proportion of the repeating units of the polyarylene ethersulfone is carboxylated and carry at least one (e.g. one or two, preferably two) carboxylate group bound to an aryl group. The carboxylate group may be present in anionic form —CO₂ or as acid form —CO₂H, wherein the anionic form may be present for as alkali metal salt (e.g. Na, K or Li).

Typically, 0.1 to 20 mol %, preferably 0.5 to 10 mol %, and in particular 1 to 5 mol % of the repeating units of the polyarylene ethersulfone carry at least one (e.g. one or two, preferably two) carboxylate group bound to an aryl group. The amount of the repeating units of the polyarylene ethersulfone which carry at least one carboxylate group bound to an aryl group can be determined using ¹H-NMR spectroscopy or potentiometric titration or IR-spectroscopy.

Suitable carboxylated polyarylene ethersulfone are based on polyarylene ethersulfone which comprise at least one (e.g. one, two or three) repeating unit selected from the formlae Ia to Io, preferably from Ia, Ig or Ik, and in particular from Ig as shown above.

The carboxylated polyarylene ethersulfone is preferably a carboxylated polysulfone (sPSU), a carboxylated polyethersulfone (sPESU), a carboxylated polyphenylenesulfone (sPPSU), or a mixture thereof.

The carboxylated polyarylene ethersulfone is in particular a carboxylated polyphenylenesulfone.

The carboxylated polyarylene ethersulfone may be prepared by sulfon carboxylatation of a polyarylether sulfone, for example by carboxylation as described in WO 2009/024973. A polyarylene ethersulfone may be reacted with n-butyl lithium, and the lithiated product reacted with carbon dioxide, and finally acidified to obtain the carboxylated polyarylene ethersulfone.

In another preferred form the carrier membrane is based on the carrier polymer obtainable by reacting
at least one aromatic dihalide (M1a),
a dialkali metal salt of at least one aromatic diol (M2a), and
at least one anionic monomer, where the anionic monomer is
   a sulfonated monomer selected from sulfonated aromatic dihalide (M1b) and/or sulfonated aromatic diol (M2b), and/or
   a carboxylic monomer selected from aromatic diols which carry a carboxylate group (M2c).

The molar ratio of (M1a+M1b):(M2a+M2b+M2c) is usually 0.95 to 1.05, in particular 0.97 to 1.03.

The molar proportion of anionic monomers M1b, M2b and/or M2c is usually in the range of 0.1 to 30 mol %, preferably 0.5 to 25 mol %, and in particular 8 to 25 mol %, based on the total mol number of the momoners M1a, M1b, M2a, M2b and M2c.

In another form the molar proportion of anionic monomers M1b and/or M2b is usually in the range of 4 to 30 mol %, preferably 6 to 25 mol %, and in particular 8 to 23 mol %, and the molar proportion of anionic monomer M2c is usually in the range of 0.1 to 15 mol %, preferably 1.0 to 8 mol %, and in particular 1.5 to 5 mol %, all based on the total mol number of the momoners M1a, M1b, M2a, M2b and M2c.

Examples of aromatic dihalides (M1a) include: bis(4-chlorophenyl)sulfone, bis(4-fluorophenyl) sulfone, bis(4-bromophenyl) sulfone, bis(4-iodophenyl) sulfone, bis(2-chlorophenyl) sulfone, bis(2-fluorophenyl) sulfone, bis(2-methyl-4-chlorophenyl) sulfone, bis(2-methyl-4-fluorophenyl) sulfone, bis(3,5-dimethyl-4-chlorophenyl) sulfone, bis(3,5-dimethyl-4-flurophenyl) sulfone and corresponding lower alkyl substituted analogs there-of. They may be used either individually or as a combination of two or more monomeric constituents thereof. Particular examples of dihalides are bis(4-chlorophenyl) sulfone (also designated (4,4′-dichlorophenyl) sulfone; DCDPS) and bis(4-fluorophenyl) sulfone.

Examples of aromatic diols (M2a) are: hydroquinone, resorcinol, 1,5-dihydroxynaphthalene, 1,6-dihydroxynaphthalene, 1,7-dihydroxynaphthalene, 2,7-dihydroxynaphthalene, 4,4′-bisphenol, 2,2′-bisphenol, bis(4-hydroxyphenyl) ether, bis(2-hydroxyphenyl) ether, 2,2-bis(4-hydroxyphenyl)propane, 2,2-bis(3-methyl-4-hydroxy-phenyl)propane, 2,2-bis(3,5-dimethyl-4-hydroyphe-nyl)propane, bis(4-hydroxyphenyl)methane, and 2,2-bis(3,5-dimethyl-4-hydroxyl)enyl)hexa-fluoropropane. Preferred of them are hydroquinone, resor-cinol, 1,5-dihydroxynaphthalene, 1,6-dihydroxynaphthalene, 1,7-dihydroxynaphthalene, 2,7-dihydroxynaphthalene, 4,4′-biphenol, bis(4-hydroxyphenyl) ether, and bis(2-hydroxyphenyl) ether. They may be used either individually or as a combination of two or more monomeric constituents M2a. Particular examples of such aromatic diols are 4,4′-bisphenol and 2,2′-bisphenol.

Suitable sulfonated monomers M1b and M2b are the mono- or poly-sulfonated equivalents of the above described non-sulfonated monomeric constituents Mia and M2a.

The sulphonated monomers are preferably of the general formulae M1b and M2b

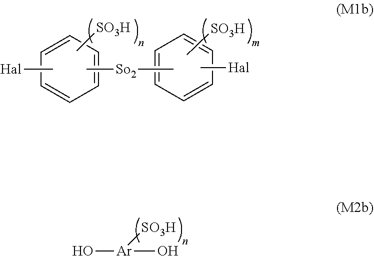

where Ar is divalent aromatic residue,
Hal is F, Cl, Br or I,
n and m independently are 0, 1 or 2, provided that n and m are not simultaneously 0,
and the aryl groups of M1a and M2a may carry at least one C₁-C₄ alkyl group.

The degree of polymerization of the thus obtained polymer may be in the range of 40 to 120, in particular 50 to 80 or 55 to 75.

In another form the sulfonated polyarylene ethersulfone is obtainable by polymerizing
a) non-sulfonated monomers of the general formulae M1a and M2a

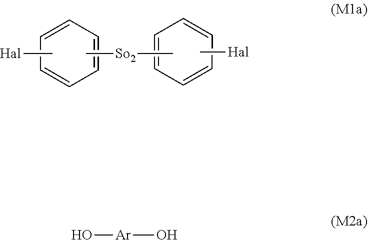

and
b) at least one sulphonated monomer of the general formulae M1b and M2b

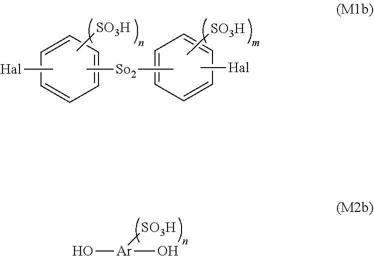

where Ar is divalent aromatic residue,
Hal is F, Cl, Br or I,
n and m independently are 0, 1 or 2, provided that n and m are not simultaneously 0,
and the aryl groups of M1a and M2a may carry at least one C₁-C₄ alkyl group.

An example for the monomer M1a is

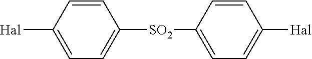

where Hal is F, Cl, Br or I.

An example for the monomer M2a is

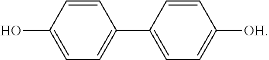 [SMILES: Oc1ccc(-c2ccc(O)cc2)cc1]

An example for the sulfonated monomer M1b is

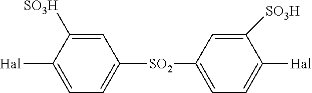

where Hal is F, Cl, Br or I.

An example for the sulfonated monomer M2b is

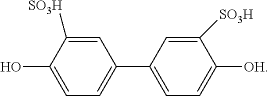 [SMILES: O=S(=O)(O)c1cc(-c2ccc(O)c(S(=O)(=O)O)c2)ccc1O]

The molar ratio of (M1a+M1b):(M2a+M2b) is usually 0.95 to 1.05, in particular 0.97 to 1.03.

The molar proportion of sulfonated monomers M1b and/or M2b is usually in the range of 0.1 to 20 mol %, preferably 0.5 to 10 mol %, and in particular 1 to 5 mol %, based on the total mol number of the momoners M1a, M1b, M2a, M2b and M2c.

The molecular weight (e.g. Mw) of the sulfonated polyarylene ethersulfone may be 10,000 to 200,000 g/mol, preferably 20,000 to 150,000 g/mol, and in particular 40,000 to 90,000 g/mol.

The carboxylic monomer is preferably of the general formula M2c

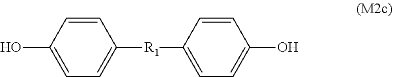

where R₁ is a divalent alkyl residue which carries a —CO₂H group. Preferably, R₁ is a divalent C₂-C₁₂ alkyl residue which carries one —CO₂H group. In particular, R₁ is C(CH₃)(CH₂—CH₂CO₂H).

An example for the carboxylated monomer M2c is

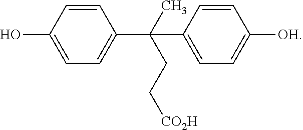 [SMILES: CC(CCC(=O)O)(c1ccc(O)cc1)c1ccc(O)cc1]

In another form the carboxylated polyarylene ethersulfone is obtainable by polymerizing
a) non-sulfonated monomers of the general formulae M1a and M2a

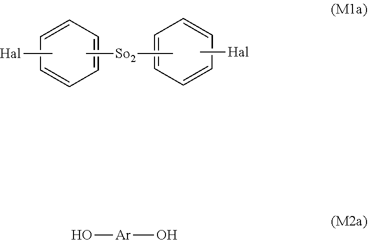

and
b) at least one carboxylic monomer of the general formula M2c

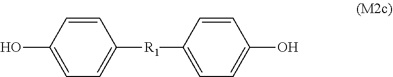

where R₁ is a divalent alkyl residue which carries a —CO₂H group.

The molar ratio of (M1a+M1b):(M2a+M2b+M2c) is usualy 0.95 to 1.05, in particular 0.97 to 1.03.

The molar proportion of carboxylated monomer M2c is usually in the range of 0.1 to 20 mol %, preferably 0.5 to 10 mol %, and in particular 1 to 5 mol %, based on the total mol number of the momoners M1a, M1b, M2a, M2b and M2c.

The method according to the invention may further comprising a step of regenerating the loaded membrane after the filtering step by a treatment with an oxidation agent or a strong acid, and a subsequent step of a treatment with the cationic polymer.

The regeneration is usually performed as chemically enhanced backwash (CEB) (also called sometimes a maintenance clean, or enhanced flux maintenance).

Suitable oxidation agents are H₂O₂, ozone, peracid, ClO₂, KMnO₄, chlorate perchlorate or hypochlorite. After the treatment with an oxidation agent the excess of oxidation agent is usually quenched, e.g. with sodium metabisulfite.

Suitable strong acids are mineral acid, such as sulfuric acid.

The treatment with the oxidation agent or the strong acid may be made at a temperature from 5 to 95° C., and within a time of 5 min to 24 h. For example, the treatment with the oxidation agent may be made at 30 to 80° C. and within 30 min to 6 h with sodium hypochlorite at alkaline pH.

The treatment with an oxidation agent or a strong acid may be followed by a subsequent step of a treatment with the cationic polymer, e.g. with an aqueous solution of the cationic polymer.

The treatment with the cationic polymer may be made at a temperature from 5 to 95° C., and within a time of 5 min to 24 h. For example, the treatment with the polyethyleneimine may be made at 10 to 50° C. and within 1 min to 2 h.

The invention further relates to the loaded membrane which contains
a carrier membrane based on a polyarylene ethersulfone which carries anionic groups (preferably carboxylate groups), and
a cationic polymer which is a polymer comprising primary and/or secondary amino groups.

In a preferred form, the loaded membrane contains
a carrier membrane based on a polyarylene ethersulfone which carries carboxylate groups, and
a cationic polymer which is polyethyleneimine.

In a form the loaded membrane contains
a carrier membrane based on a polyarylene ethersulfone which carries carboxylate groups, and
a cationic polymer which is a polymer comprising primary and/or secondary amino groups, where the carrier mebrane is based on a carrier polymer obtainable by reacting
at least one aromatic dihalide (M1a),
a dialkali metal salt of at least one aromatic diol (M2a), and
at least one anionic monomer, where the anionic monomer is a carboxylic monomer selected from aromatic diols which carry a carboxylate group (M2c).

In another form of the loaded membrane the carboxylic monomer is of the general formula M2c

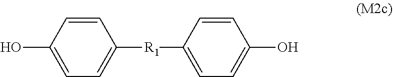

where R₁ is a divalent alkyl residue which carries a —CO₂H group.

In another form of the loaded membrane the loaded membrane is an ultrafiltration membrane, and where the PWP is from 20 to 500 LMH/bar.

The loaded membrane is usually obtainable by treating the carrier membrane with a solution of the cationic polymer.

The solution of the cationic polymer may comprise from 0.1 to 20 wt %, preferably from 1 to 10 wt % of the cationic polymer.

The treatment of the carrier membrane with the solution of the cationic polymer may be made at a temperature from 5 to 95° C., and within a time of 5 min to 24 h. For example, the treatment with the polyethyleneimine may be made at 10 to 50° C. and within 1 min to 2 h.

The loaded membranes may be present as spiral wound membranes, pillows or flat sheet membranes, tubular membranes, hollow fiber membranes or capillaries, single bore hollow fiber membranes, or multibore hollow fiber membranes.

Multiple channel membranes, also referred to as multibore membranes, comprise more than one longitudinal channels also referred to simply as “channels”. In a preferred embodiment, the number of channels is typically 2 to 19. In one embodiment, multiple channel membranes comprise two or three channels. In another embodiment, multiple channel membranes comprise 5 to 9 channels. In one preferred embodiment, multiple channel membranes comprise seven channels. In another embodiment the number of channels is 20 to 100. The shape of such channels, also referred to as “bores”, may vary. In one embodiment, such channels have an essentially circular diameter. In another embodiment, such channels have an essentially ellipsoid diameter. In yet another embodiment, channels have an essentially rectangular diameter. In some cases, the actual form of such channels may deviate from the idealized circular, ellipsoid or rectangular form. Normally, such channels have a diameter (for essentially circular diameters), smaller diameter (for essentially ellipsoid diameters) or smaller feed size (for essentially rectangular diameters) of 0.05 mm to 3 mm, preferably 0.5 to 2 mm, more preferably 0.9 to 1.5 mm. In another preferred embodiment, such channels have a diameter (for essentially circular diameters), smaller diameter (for essentially ellipsoid diameters) or smaller feed size (for essentially rectangular diameters) in the range from 0.2 to 0.9 mm. For channels with an essentially rectangular shape, these channels can be arranged in a row. For channels with an essentially circular shape, these channels are in a preferred embodiment arranged such that a central channel is surrounded by the other channels. In one preferred embodiment, a mem-brane comprises one central channel and for example four, six or 18 further channels arranged cyclically around the central channel. The wall thickness in such multiple channel membranes is normally from 0.02 to 1 mm at the thinnest position, preferably 30 to 500 μm, more preferably 100 to 300 μm. Normally, the membranes and carrier membranes have an essentially circular, ellipsoid or rectangular diameter. Preferably, membranes are essentially circular. In one preferred embodiment, membranes according to the invention have a diameter (for essentially circular diameters), smaller diameter (for essentially ellipsoid diameters) or smaller feed size (for essentially rectangular diameters) of 2 to 10 mm, preferably 3 to 8 mm, more preferably 4 to 6 mm. In another preferred embodiment, membranes have a diameter (for essentially circular diameters), smaller diameter (for essentially ellipsoid diameters) or smaller feed size (for essentially rectangular diameters) of 2 to 4 mm. In one embodiment the rejection layer is located on the inside of each channel of said multiple channel membrane. In one embodiment, the channels of a multibore membrane may incorporate an active layer with a pore size different to that of the carrier membrane or a coated layer forming the active layer. Suitable materials for the coated layer are polyoxazoline, polyethylene glycol, polystyrene, hydrogels, polyamide, zwitterionic block copolymers, such as sulfobetaine or carboxybetaine. The active layer can have a thickness in the range from 10 to 500 nm, preferably from 50 to 300 nm, more preferably from 70 to 200 nm. In one embodiment multibore membranes are designed with pore sizes between 0.2 and 0.01 μm. In such embodiments the inner diameter of the capillaries can He between 0.1 and 8 mm, preferably between 0.5 and 4 mm and particularly preferably between 0.9 and 1.5 mm. The outer diameter of the multibore membrane can for example He between 1 and 26 mm, preferred 2.3 and 14 mm and particularly preferred between 3.6 and 6 mm. Furthermore, the multibore membrane can contain 2 to 94, preferably 3 to 19 and particularly preferred between 3 and 14 channels. Often multibore membranes contain seven channels. The permeability range can for example He between 100 and 10000 L/m²hbar, preferably between 300 and 2000 L/m² hbar.

The invention offers various advantages: It allows the filtration, especially the ultrafiltration, and the removal of metal ions in one step; there is no need for an separate, costly ion exchange step; the loaded membrane can regenerated and optionally stored during the conventional membran washing steps, such as chemical back wash cycles; and the cationic polymer can be flexible adjusted for various target metal ions.

### EXAMPLES

PPSU-1: A polyphenylenesulfone (PPSU) with a viscosity number (ISO 307, 1157, 1628; in 0.01 g/mol phenol/1,2 orthodichlorobenzene 1:1 solution) of 71 and a glass transition temperature (DSC, 10° C./min; according to ISO 11357-1/-2) of 220° C.
PVP-1: A polyvinylpyrrolidone with a solution viscosity characterised by the K-value of 90, determined according to the method of Fikentscher.
PEI-1: Aqueous polyethyleneimine solution with a concentration of 99% (ISO3251), a viscosity number >200000 mPa*s (ISO 2555) and an average molecular weight of 25000 g/mol (GPC).
PEI-2: Aqueous polyethyleneimine solution (FG) with a concentration of 99% (ISO3251), a viscosity number of 5000 mPa*s (ISO 2555) and an average molecular weight of 800 g/mol (GPC).

### Example 1—Synthesis of Anionic Polymer “DPAcoPPSU-11.2”

In a 4 l vessel equipped a with stirrer, Dean-Stark-trap, nitrogen inlet and temperature control 585.8 g (2.04 mol) of dichlorodiphenyl sulfone, 335.2 g (1.80 mol) of dihydroxydiphenyl and 57.2 g (0.20) of bis-4,4-(4-hydroxyphenyl)valeric acid were dissolved, under nitrogen, in 1538 ml of N-methylpyrrolidone and mixed with 317 g (2.30 mol) of anhydrous potassium carbonate. The reaction mixture was firstly heated at 180° C., for 1 h at a pressure of 300 mbar, the water of reaction and N-methylpyrrolidone being continuously distilled off, and then reacted for 6 h at 190° C. After adding 1462 ml of N-methylpyrrolidone, the inorganic constituents were filtered off. Basic groups were neutralized by adding 300 ml of glacial acetic acid and the polymer was then isolated by precipitation in water. After three extractions with water, the product was dried under reduced pressure at 140° C., giving a white powder (DPAcoPPSU-11.2).

The proportion of units having acid groups was determined using ¹H-NMR as 11.2 mol % and the viscosity number of the product was 66.3 ml/g.

### Example 2—Synthesis of Anionic Polymer “DPAcoPPSU-17”

In a 4 l vessel equipped a with stirrer, Dean-Stark-trap, nitrogen inlet and temperature control 585.8 g (2.04 mol) of dichlorodiphenyl sulfone, 316.6 g (1.70 mol) of dihydroxydiphenyl and 85.9 g (0.30 mol) of bis-4,4-(4-hydroxyphenyl)valeric acid were dissolved, under nitrogen, in 1538 ml of N-methylpyrrolidone and mixed with 331.7 g (2.40 mol) of anhydrous potassium carbonate. The reaction mixture was firstly heated at 180° C., for 1 h at a pressure of 300 mbar, the water of reaction and N-methylpyrrolidone being continuously distilled off, and then reacted for 6 h at 190° C. After adding 1462 ml of N-methylpyrrolidone, the inorganic constituents were filtered off. Basic groups were neutralized by adding 300 ml of glacial acetic acid and the polymer was then isolated by precipitation in water. After three extractions with water, the product was dried under reduced pressure at 140° C., giving a white powder (DPAcoPPSU-17).

The proportion of units having acid groups was determined using ¹H-NMR as 17 mol % and the viscosity number of the product was 61.3 ml/g.

### Example 3—Synthesis of Anionic Polymer “DPAcoPPSU-20.6”

In a 4 l vessel equipped a with stirrer, Dean-Stark-trap, nitrogen inlet and temperature control 582.9 g (2.03 mol) of dichlorodiphenyl sulfone, 297.9 g (1.60 mol) of dihydroxydiphenyl and 114.5 g (0.40 mol) of bis-4,4-(4-hydroxyphenyl)valeric acid were dissolved, under nitrogen, in 1538 ml of N-methylpyrrolidone and mixed with 345.5 g (2.50 mol) of anhydrous potassium carbonate. The reaction mixture was firstly heated at 180° C., for 1 h at a pressure of 300 mbar, the water of reaction and N-methylpyrrolidone being continuously distilled off, and then reacted for 6 h at 190° C. After adding 1462 ml of N-methylpyrrolidone, the inorganic constituents were filtered off. Basic groups were neutralized by adding 300 ml of glacial acetic acid and the polymer was then isolated by precipitation in water. After three extractions with water, the product was dried under reduced pressure at 140° C., giving a white powder (DPAcoPPSU-20.6).

The proportion of units having acid groups was determined using ¹H-NMR as 20.6 mol % and the viscosity number of the product was 61.7 ml/g.

### Example 4—Synthesis of Anionic Polymer “sPPSU-2.4”

In a 4 l vessel equipped a with stirrer, Dean-Stark-trap, nitrogen inlet and temperature control, a reaction mixture was provided, by suspending 580.1 g (2.02 mol) of 4,4′-dichlorodiphenylsulfone (DCDPS), 335.2 g (1.80 mol) of 4,4′-dihydroxybiphenyl (DHB), 45.7 g (0.2 mol) bisphenol A, 14.7 g (0.03 mol) of 4,4′-dichlorodiphenylsulfone-3,3′-disulfonic acid disodium salt and 293 g (2.12 mol) of potassium carbonate nitrogen atmosphere in 1250 ml of N-methylpyrrolidone. The reaction mixture was heated to 190° C. under stirring and kept at 190° C. for 6 h, during which nitrogen was purged through the reaction mixture at 30 I/h. Subsequently, 1750 ml of N-methylpyrrolidone was added and the reaction mixture was cooled down to 60° C. under nitrogen. The reaction mixture was filtered and precipitated in water comprising g 100 ml HCl (2 M). The precipitated product was extracted with hot water for 20 h at 85° C. and dried at 120° C. for 24 h under reduced pressure to obtain the sulfonated polyphenylene sulfone (sPPSU-2.4).

The proportion of units having acid groups was determined using+1-NMR as 2.4 mol % and the viscosity number of the product was 77.0 ml/g (1 wt/vol-% solution in N-methylpyrrolidone at 25° C.).

### Example 5—Synthesis of Anionic Polymer “sPPSU-2.1”

In a 4 l vessel equipped a with stirrer, Dean-Stark-trap, nitrogen inlet and temperature control, a reaction mixture was provided, by suspending 580.1 g (2.02 mol) of 4,4′-dichlorodiphenylsulfone (DCDPS), 335.2 g (1.80 mol) of 4,4′-dihydroxybiphenyl (DHB), 45.7 g (0.2 mol) bisphenol A, 14.7 g (0.03 mol) of 4,4′-dichlorodiphenylsulfone-3,3′-disulfonic acid disodium salt and 293 g (2.12 mol) of potassium carbonate nitrogen atmosphere in 1250 ml of N-methylpyrrolidone. The reaction mixture was heated to 190° C. under stirring and kept at 190° C. for 6 h, during which nitrogen was purged through the reaction mixture at 30 I/h. Subsequently, 1750 ml of N-methylpyrrolidone was added and the reaction mixture was cooled down to 60° C. under nitrogen. The reaction mixture was filtered and precipitated in water comprising g 100 ml HCl (2 M). The precipitated product was extracted with hot water for 20 h at 85° C. and dried at 120° C. for 24 h under reduced pressure to obtain the sulfonated polyphenylene sulfone (sPPSU-2.1).

The proportion of units having acid groups was determined using ¹H-NMR as 2.1 mol % and the viscosity number of the product was 75.2 ml/g (1 wt/vol-% solution in N-methylpyrrolidone at 25° C.).

### Example 6—Preparation of Carrier Membrane

Into a three-neck flask equipped with a magnetic stirrer there were added 65 ml of N-methylpyrrolidone, 6 g PVP-1, 10 g 1,2-propandiol and 19 g of one of the polymers from the Examples 1 to 5. The mixture was heated under gentle stirring at 60° C. until a homogeneous clear viscous solution was obtained. The solution was degassed overnight at room temperature. After that the membrane solution was reheated at 60° C. for 2 hours and casted onto a glass plate with a casting knife (300 microns) at 60° C. using an Erichsen Coating machine operating at a speed of 5 mm/min. The membrane film was allowed to rest for 30 seconds before immersion in a water bath at 25° C. for 10 minutes to coagulate the polymers to form the carrier membrane.

Workup of the membrane: After the membrane had detached from the glass plate, the membrane was carefully transferred into a water bath for 12 h. Afterwards the membrane was transferred into a bath containing 2500 ppm NaOCl at 50° C. for 4.5 h to remove polyvinylpyrrolidone. The membrane was then washed with water at 60° C. and one time with a 0.5 wt.-% solution of sodium bisulfite to remove active chlorine. After several washing steps with water the membrane was stored wet until characterization as described in Example 7.

### Example 7—Characterization of Carrier Membrane

The membranes prepared in Example 6 including the corresponding Comparative Membrane based on PPSU-1 were characterized. The results are summarized in Table 1.

The pure water permeation (PWP in kg/h*m²*bar) of the membranes was tested using a pressure cell with a diameter of 60 mm using ultrapure water (salt-free water, filtered by a Millipore UF-system). In a subsequent test, a solution of different PEG-Standards was filtered at a pressure of 0.15 bar. By GPC-measurement of the feed and permeate, the molecular weight cut-off (MWCO in kDa) of the membranes were determined.

TABLE 1
Pure water permeation (PWP) and molecular weight cut-off
(MWCO) of membranes

| | | PWP | MWCO |
|---|---|---|---|
| Carrier Membrane | Based on polymer | [kg/h * m² * bar] | [kDa] |
| Example 7.1 | DPAcoPPSU-11.3 | 390 | 26 |
| Example 7.2 | DPAcoPPSU-17.0 | 465 | 30 |
| Example 7.3 | DPAcoPPSU-20.6 | 385 | 16 |
| Example 7.4 | sPPSU-2.4 | 310 | 25 |
| Example 7.5 | sPPSU-2.1 | 410 | 30 |
| Comparative 7.6 | PPSU-1 | 540 | 17 |

### Example 8—Loading of Membranes with Cationic Polymers

The membranes prepared in Example 6 and characterized in Example 7 were stored in 0.1 N sulfuric acid for 15 min, then rinsed with water until neutral and subsequently stored for 15 min in an aqueous coating solution, which contained 5 wt % of a cationic polymer as listed in Table 2. Finally the sample was rinsed until the washing water is pH neutral. The results of the characterization are summarized in Table 2.

The data demonstrated that different cationic polymer can be flexible loaded to the carrier membrane, and that the loaded membranes have a high quality regarding PWP and MWCO.

TABLE 2
Pure water permeation (PWP) and molecular weight cut-off (MWCO) of membranes

| Carrier | | Cationic | PWP | MWCO |
|---|---|---|---|---|
| Membrane | Based on polymer | polymer | [kg/h*m²*bar] | [kDa] |
| Example 8.1 | DPAcoPPSU-11.3 | PEI-2 | 70 | 2.9 |
| Example 8.2 | DPAcoPPSU-17.0 | PEI-1 | 100 | 14 |
| Example 8.3 | DPAcoPPSU-20.6 | PEI-2 | 60 | 8 |
| Example 8.4 | sPPSU-2.4 | PEI-2 | 110 | 15 |
| Example 8.5 | sPPSU-2.1 | PEI-1 | 280 | 29 |
| Comparative 8.6 | PPSU-1 | PEI-2 | 540 | 17 |

### Example 9—Regenerating the Loaded Membrane

The loaded membranes, which were prepared in Example 8, were transferred into a bath containing 2500 ppm NaOCl at 50° C. for 4.5 h to remove the coating. The membrane was then washed with water at 60° C. and after several times rinsing with water the membrane was stored wet until characterization as summarized in Table 3.

The data demonstrated that the PWP and MWCO after regeneration is in the similar range as the original carrier membrane (cf Table 1). Thus, it was shown that the loaded membrane can be regenerated and optionally stored during the conventional membran washing steps, such as chemical back wash cycles.

TABLE 3
Pure water permeation (PWP) and molecular weight cut-off (MWCO) of membranes

| | | Cationic | PWP | MWCO |
|---|---|---|---|---|
| Example | Based on polymer | polymer | [kg/h*m² * bar] | [kDa] |
| Example 9.1 | DPAcoPPSU-11.3 | PEI-2 | 640 | 23 |
| Example 9.2 | DPAcoPPSU-17.0 | PEI-1 | 660 | 26 |
| Example 9.3 | DPAcoPPSU-20.6 | PEI-2 | 530 | 17 |
| Example 9.4 | sPPSU-2.4 | PEI-2 | 320 | 30 |
| Example 9.5 | sPPSU-2.1 | PEI-1 | 400 | 33 |
| Comparative 9.6 | PPSU-1 | PEI-2 | 525 | 17 |

### Example 10—Metal Ion Binding Capacity of Loaded Membrane

Metal ion concentrations of the loaded membranes prepared in Example 8 in aqueous solutions were determined with a photometer NOVA 60 Spectroquant® (Merck KGaA) using the test sets for copper (0.05-8.00 mg/I Cu; No. 1.14553.0001) and nickel (0.1-6.00 mg/I Ni; No. 1.14554.0001).

Circular membrane specimen of 7.4 cm diameter (43 cm²) was punched out and stored in 4.16 ppm solution of CuSO₄ or 5.18 ppm NiSO₄ aqueous solution. After 60 minutes the concentration was estimated again and the metal ion binding capacity calculated.

The data demonstrated that the loaded membranes allow not only the filtration with a MWCO as analyzed in Table 2, but in addition the removal of metal ions.

TABLE 4
Metal ion binding capacity of loaded membranes

| | | Cationic | Cu (II) | Ni (II) |
|---|---|---|---|---|
| Example | Based on polymer | polymer | [mg/m²] | [mg/m²] |
| Example 10.1 | DPAcoPPSU-11.3 | PEI-2 | 29 | 11 |
| Example 10.2 | DPAcoPPSU-17.0 | PEI-1 | 7 | 17 |
| Example 10.3 | DPAcoPPSU-20.6 | PEI-2 | 24 | 13 |
| Example 10.4 | sPPSU-2.4 | PEI-2 | 13 | 4 |
| Example 10.5 | sPPSU-2.1 | PEI-1 | 19 | 17 |
| Comparative 10.6 | PPSU-1 | PEI-2 | <1 | 1 |

1. A method for removing metal ions from an aqueous system comprising a step of filtering the aqueous system through a loaded membrane which contains
a carrier membrane based on a polyarylene ethersulfone which carries anionic groups, and
a cationic polymer which is a polymer comprising primary and/or secondary amino groups.

2. The method according to claim 1 where the cationic polymer is polyethyleneimine, polyethyleneimine-polyvinylalcohol, poly-L-lysine, diethylaminoethyl-dextran, chitosan, polyetheramine, and polymers based on vinylamine.

3. The method according to claim 1 or 2 where the anionic groups are sulfonate, carboxylate, or phosphonate groups.

4. The method according to any of claims 1 to 3 where the carrier mebrane is based on
a) a sulfonated polyarylene ethersulfone;
b) a carboxylated polyarylene ethersulfone; or
c) a carrier polymer obtainable by reacting
at least one aromatic dihalide (M1a),
a dialkali metal salt of at least one aromatic diol (M2a), and
at least one anionic monomer, where the anionic monomer is
a sulfonated monomer selected from sulfonated aromatic dihalide (M1b) and/or sulfonated aromatic diol (M2b), and/or
a carboxylic monomer selected from aromatic diols which carry a carboxylate group (M2c).

5. The method according to claim 4 where the sulphonated monomers are of the general formulae M1b and M2b 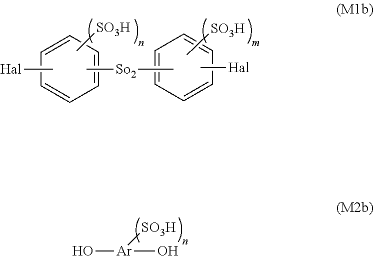
where Ar is divalent aromatic residue,
Hal is F, Cl, Br or I,
n and m independently are 0, 1 or 2, provided that n and m are not simultaneously 0, and the aryl groups of M1a and M2a may carry at least one C₁-C₄ alkyl group.

6. The method according to claim 4 where the carboxylic monomer is of the general formula M2c 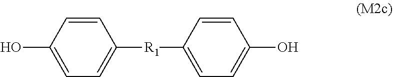
where R₁ is a divalent alkyl residue which carries a —CO₂H group.

7. The method according to any of claims 1 to 6 where 0.1 to 40 mol %, preferably 0.3 to 30 mol %, and in particular 0.5 to 25 mol % of the repeating units of the polyarylether sulfone carry at least one anionic group.

8. The method according to any of claims 1 to 7 where the metal ions are selected from Ca, Mg, Al, Cu, Ni, Pb, Zn, Sb, Co, Cr, Cd, Hg, Po, Ra, Rn, Th, U, Pu, Sr, Cs, Pm and/or Ag.

9. The method according to any of claims 1 to 8 where the carrier membrane has a molecular weight cut-off from 20,000 to 200,000 Da, and the loaded membrane has a molecular weight cut of below 20,000 Da.

10. The method according to any of claims 1 to 9 where the loaded membrane is an ultrafiltration membrane.

11. The method according to any of claims 1 to 10 where the loaded membrane has a pure water permeability from 20 to 500 LMH/bar.

12. The method according to any of claims 1 to 11 where the carrier membrane has a pure water permeability from 200 to 1000 LMH/bar.

13. The method according to any of claims 1 to 12 further comprising a step of regenerating the loaded membrane after the filtering step by a treatment with an oxidation agent or a strong acid, and a subsequent step of a treatment with the cationic polymer.

14. A loaded membrane as defined in any of claims 1 to 13 which contains
a carrier membrane based on a polyarylene ethersulfone which carries carboxylate groups, and
a cationic polymer which is a polymer comprising primary and/or secondary amino groups,
where the carrier mebrane is based on a carrier polymer obtainable by reacting
at least one aromatic dihalide (M1a),
a dialkali metal salt of at least one aromatic diol (M2a), and
at least one anionic monomer, where the anionic monomer is a carboxylic monomer selected from aromatic diols which carry a carboxylate group (M2c).

15. The loaded membrane according to claim 14 where the carboxylic monomer is of the general formula M2c 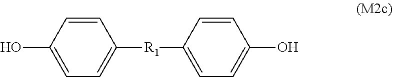
where R₁ is a divalent alkyl residue which carries a —CO₂H group.

16. The loaded membrane according to claim 14 or 15 where the loaded membrane is an ultrafiltration membrane, and where the PWP is from 20 to 500 LMH/bar.
